(19) United States
(12) Patent Application Publication
(10) Pub. No.: US 2014/0214183 A1
(43) Pub. Date: Jul. 31, 2014

(54) INDUSTRIAL PLANT PRODUCTION AND/OR CONTROL UTILIZATION OPTIMIZATION

(71) Applicant: ABB TECHNOLOGY AG., Zurich (CH)

(72) Inventors: TIMOTHY ANDREW MAST, Plain City, OH (US); KEVIN DALE STARR, Lancaster, OH (US)

(73) Assignee: ABB TECHNOLOGY AG., Zurich (CH)

(21) Appl. No.: 13/751,276

(22) Filed: Jan. 28, 2013

(51) Int. Cl. G05B 15/02

(52) U.S. Cl. CPC G05B 15/02
USPC 700/32

(57) ABSTRACT

A method includes obtaining production and control utilization information for an industrial plant, wherein the information is in an electronic format and collected over time, grouping the information, based on a type of the information, into a plurality of groups, wherein the information in each group is for a same type of information, trending the information in each group over time, aggregating the trended information, evaluating the aggregated information based on predetermined evaluation criteria, and generating an electronic signal indicating the information that satisfied the predetermined evaluation criteria and the information that did not satisfy the predetermined evaluation criteria.

### BACKGROUND

The following generally relates to industrial plant production and/or control utilization optimization and is described with particular application to a pulp and paper plant; however, the following is also amenable to other industrial plants such as chemicals, pharmaceuticals, marine, metals, minerals, oil and gas, turbocharging, performance services, and/or other plants.

Industrial plants include various control systems to control machinery therein which produce products. Historical data has shown that a plant's utilization of its control systems ultimately affects production output. In particular, historical data has shown that production output typically decreases with the decreased utilization of the control systems set in place to control production. Decreased utilization, generally, means that a particular control system is used less than expected.

Techniques for monitoring control system utilization and production have included plant site visits in which machine operations are examined for a period of time. This information can be extrapolated to provide insight into the long term performance of the machine. It may also result in the collection of data which can be used to determine local and/or industry wide benchmarks or a baseline against which to gauge future performance improvements.

Unfortunately, such techniques require the consumption of a technician's time to collect all the data and make decisions based thereon. By way of example, such monitoring may require a scheduled visit to a plant by a technician in which the technician manually collects data over a short period of time. This information is then gleaned over and inferences about plant operation are made. Conclusions can then be drawn as to improve production, for example, by following and/or changing the planned control system utilization.

With a pulp and paper plant, this may include obtaining and evaluating data such as production information such as output, reel speed, run time, lost time, etc. and control information such as whether a particular control system was on or off and the percentage of time the particular control system was on or off. With this example, the information may show a correlation between the production of a paper roll with unacceptable moisture contact, for example, and lack of utilization of the moisture control system.

### SUMMARY

Aspects of the present application address these matters, and others.

According to one aspect, a method includes obtaining production and control utilization information for an industrial plant, wherein the information is in an electronic format and collected over time, grouping the information, based on a type of the information, into a plurality of groups, wherein the information in each group is for a same type of information, trending the information in each group over time, aggregating the trended information, evaluating the aggregated information based on predetermined evaluation criteria, and generating an electronic signal indicating the information that satisfied the predetermined evaluation criteria and the information that did not satisfy the predetermined evaluation criteria.

According to another aspect, a system includes memory that stores computer executable instructions and a processor that executes the computer executable instructions. The processor, when executing the computer executable instructions, implements: a parser that groups production and control utilization information for an industrial plant, based on a type of the information, into a plurality of groups, wherein the information in each group is for a same type of information, a trender that trends the information in each group over time, an aggregator that aggregates the trended information, an evaluator that evaluates the aggregated information based on predetermined evaluation criteria, and a report generator that generates an electronic signal indicating the information that satisfied the predetermined evaluation criteria and the information that did not satisfy the predetermined evaluation criteria.

According to another aspect, a computer readable storage medium is encoded with one or more computer executable instructions, which, when executed by a processor of a computing system, causes the processor to: obtain production and control utilization information for an industrial plant, wherein the information is in an electronic format and collected over time, group the information, based on a type of the information, into a plurality of groups, wherein the information in each group is for a same type of information, trend the information in each group over time, aggregate the trended information, evaluate the aggregated information based on predetermined evaluation criteria, and generate an electronic signal indicating the information that satisfied the predetermined evaluation criteria and the information that did not satisfy the predetermined evaluation criteria.

Those skilled in the art will appreciate still other aspects of the present application upon reading and understanding the attached figures and description.

### FIGURES

The present application is illustrated by way of example and not limitation in the figures of the accompanying drawings, in which like references indicate similar elements and in which:

FIG. 1 illustrates an example system for analyzing production and control utilization of an industrial plant.

FIG. 2 illustrates an example pulp and paper industrial plant.

FIG. 3 illustrates an example data analyzer.

FIG. 4 illustrates an example of pulp and paper production and control utilization information.

FIG. 5 illustrates an example plot of lost time over time.

FIG. 6 illustrates an example of various production related items aggregated by shift and month.

FIG. 7 illustrates an example of control utilization related items aggregated by shift and month.

FIG. 8 illustrates an example plot of production variability as a function of time.

FIG. 9 illustrates an example bar graph with a predetermined utilization threshold.

FIG. 10 illustrates another example plot of lost time over time.

FIG. 11 illustrates an example report showing monthly utilization in three dimensions.

FIG. 12 illustrates an example report including a control utilization bar graph.

FIG. 13 illustrates an example report including a monthly utilization by controller bar graph.

FIG. 14 illustrates an example report showing first and second trends and a combined trend.

FIG. 15 illustrates a method.

### DESCRIPTION

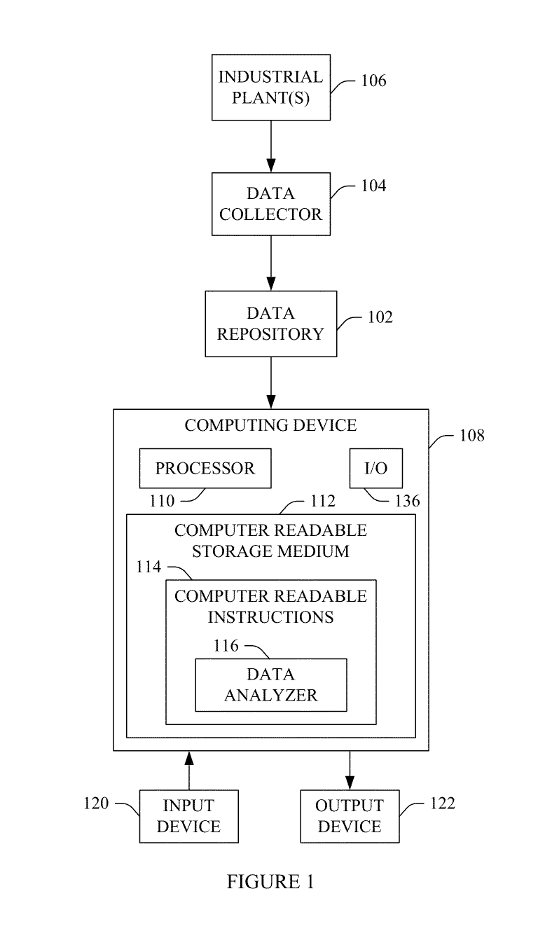

Initially referring to FIG. 1, a data repository 102 stores production and/or control information collected by a data collector 104 or the like from one or more industrial plants 106 such as pulp and paper, chemicals, pharmaceuticals, marine, metals, minerals, oil and gas, turbocharging, performance services, and/or other plants. For sake of brevity, the following will be discussed in connection with a pulp and paper plant.

In the context of pulp and paper, such information may include production information such as average speed, thru put, reel speed, run time, lost time, grade change, etc., and control system utilization information such as machine direction controls loop utilization, cross machine direction control loop utilization, and/or other control utilization. Although these are for pulp and paper, some (e.g., time lost) may overlap with other industries.

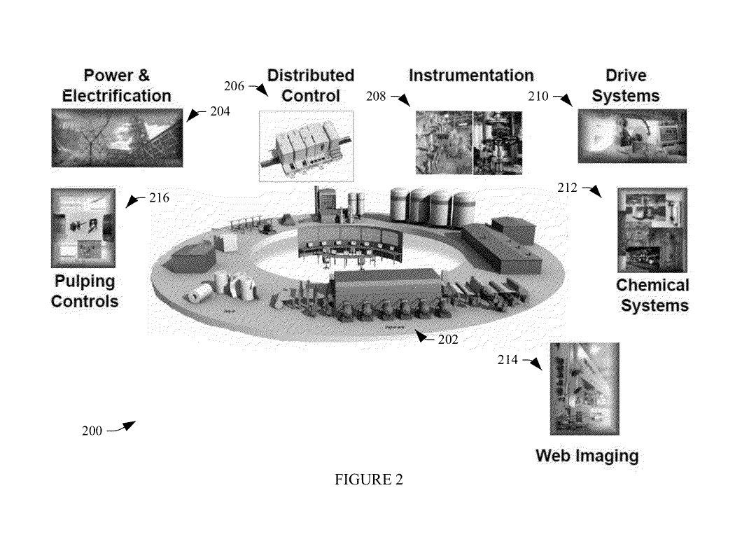

Briefly turning to FIG. 2, an example pulp and paper plant 200 is shown and includes a paper mill 202, power and electrification equipment 204, distributed control equipment 206, instrumentation 208, drive systems 210, chemical systems 212, web imaging 214, and pulping controls 216. An example paper mill 202 is described in U.S. Pat. No. 7,648,614, assigned to ABB, which is incorporated herein in its entirety by reference.

Returning to FIG. 1, such data can be collected continuously or based on a predetermined frequency. An example of the latter includes by minute, hourly, daily, shift by shift, weekly, monthly, etc. Another example of the latter includes a combination such as daily, per shift each day. Other approaches are also contemplated herein. Such data may be collected and/or provided by various entities such as ABB, OSIsoft, Aspen Tech, Capstone, Majiq, Mops, and/or other entity.

A computing device 108 includes a processor(s) 110 and computer readable storage medium 112 encoded with computer readable instructions 114, which, when executed by the processor 110 causes the computing device 108 to execute the instructions 114. In one instance, the instructions 114 include instructions for implementing a data analyzer 116, which evaluates various data stored in the data repository 102.

The computer readable storage medium 112 includes physical memory and/or other non-transitory memory. However, the processor 110 can also execute computer readable instructions carried by a signal, carrier wave, and/or other transitory medium. One or more of the instructions for implementing the data analyzer 116 can be carried by the transitory medium can include instructions, which evaluates various data stored in the data repository 102.

I/O 136 is configured for receiving information from one or more input devices 120 (e.g., a keyboard, a mouse, and the like) and/or conveying information to one or more output devices 122 (e.g., a monitor, a printer, portable memory, etc.).

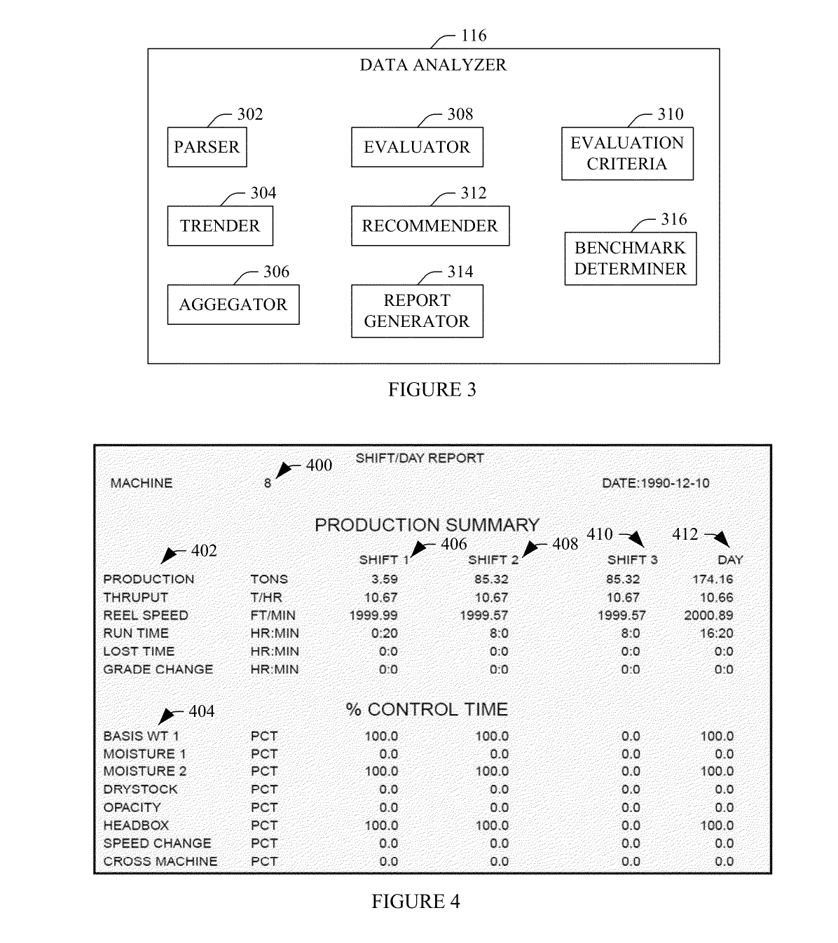

Turning to FIG. 3, an example of the data analyzer 116 is illustrated. In this example, the data analyzer includes a parser 302, a trender 304, an aggregator 306, an evaluator 308, predetermined evaluation criteria 310, a recommender 312, a report generator 314, and a benchmark determiner 316.

The parser 302 parses information obtained from the data repository 102, separating the data into groups by type of data. FIG. 4 shows an example of the information collected for a particular paper machine 400 over a course of a day, delineated by production related items 402 and control related items 404, over shifts 406, 408 and 410, aggregated over a day 412. Returning to FIG. 3, the parser 302 parses such information into groups of related information.

For example, the parser 302 may parse reel speed information into one group, and machine direction control loop utilization into another group, etc. The grouped information will also include a machine unique identification, date and time stamp, etc. Examples of other groups include, but are not limited to, average speed, thruput, run time, lost time, grade change, machine direction controls loop utilization, cross machine direction control loop utilization, and/or other information.

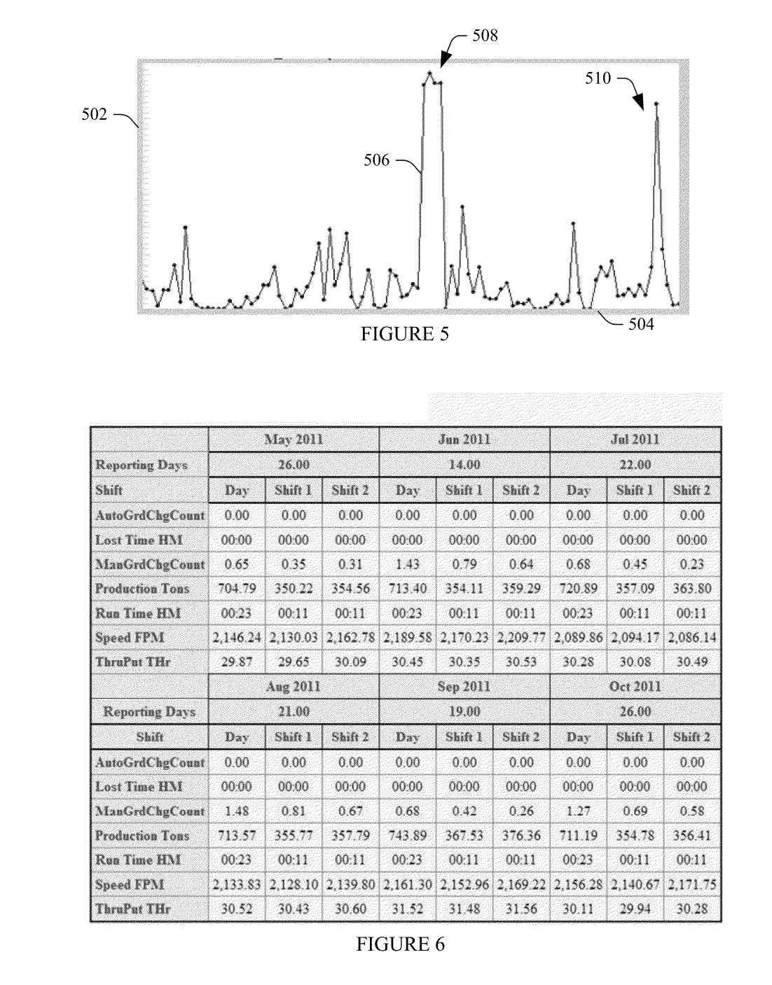

The trender 304 trends the parse information in one or more of the groups. For example, the trender 304 may trend lost time over time. An example of this is shown in FIG. 5, where a y-axis 502 represents lost time and an x-axis 504 represents time. In FIG. 5, a plot 506 show lost time over time. In this example, region 508 and 510 indicate periods of lost time that are much larger than the rest of the time. Such trending can be trended on a per minute, hour, day, week, month, etc. basis.

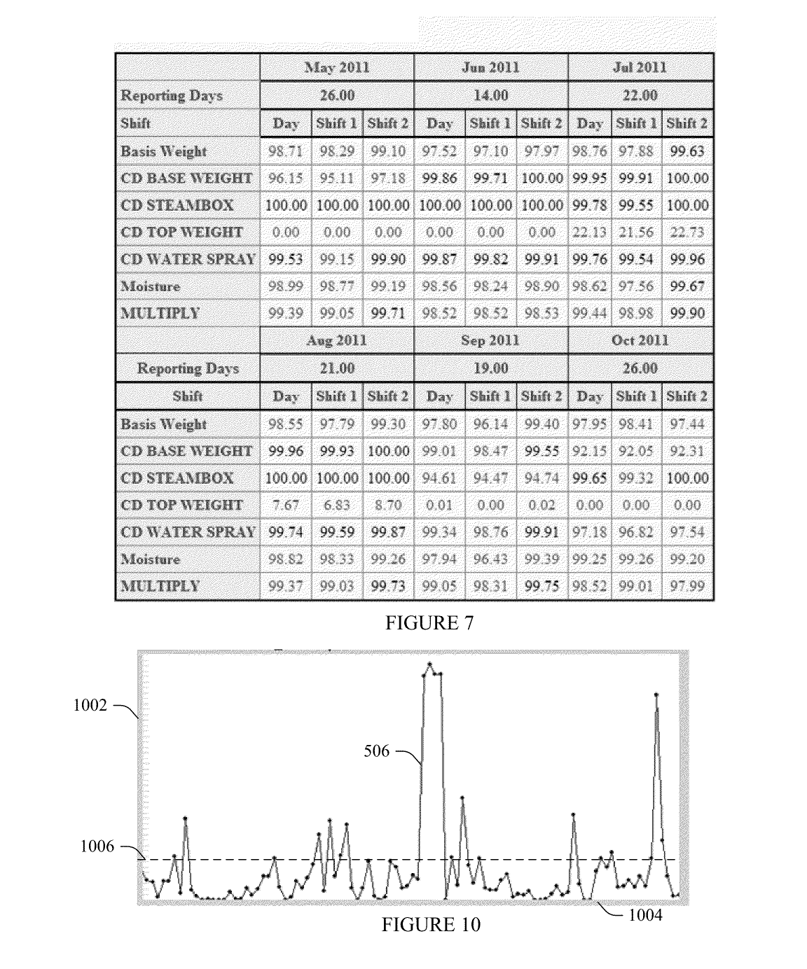

Returning to FIG. 3, the aggregator 306 aggregates the trended data. For example, the aggregator 306 may aggregate trends for reel speed, output, thruput, moisture control, etc. together based on a per minute, hour, shift, day, week, month, etc. basis. FIG. 6 shows an example of various production related items aggregated by shift and month. For example, “production tons” is shown for a first month to be 704.79 for day shift 412, 350.22 for first shift, and 354.56 for second shift. FIG. 7 shows an example of control utilization related items aggregated by shift and month. For example, “CD base weight” is shown for a first month to be 96.15% for day shift, 95.11% for first shift, and 97.18% for second shift.

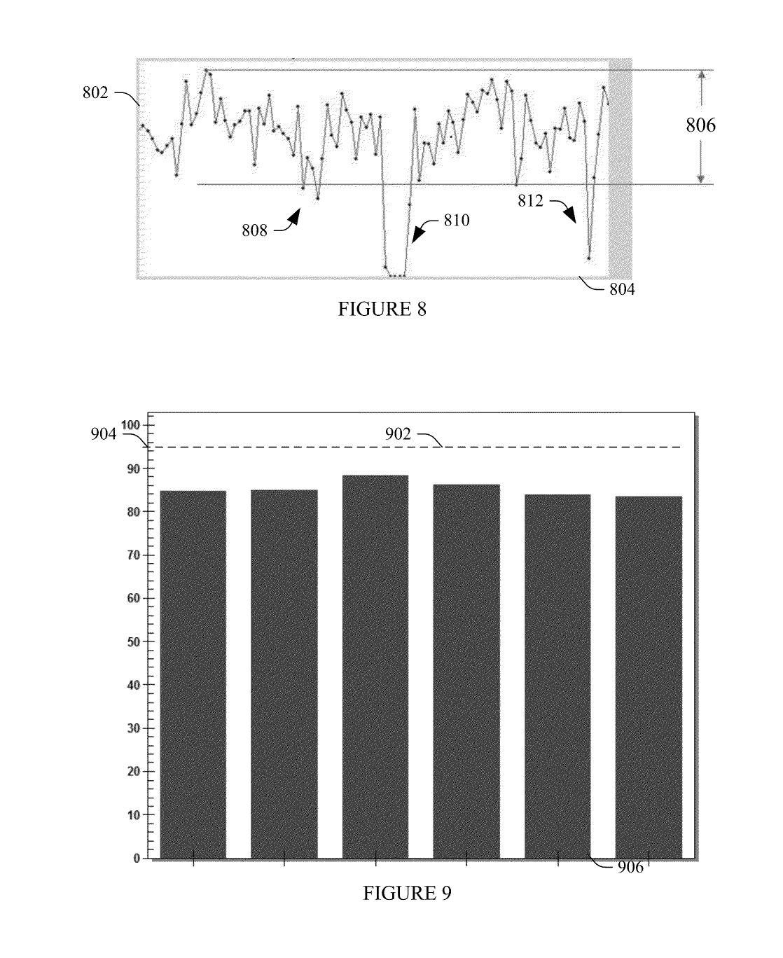

Returning to FIG. 3, the evaluator 308 evaluates the aggregated data based on predetermined evaluation criteria 310. By way of example, the predetermined evaluation criteria 310 may indicate that production should be at a predetermined level of variability or achieve with a predetermined level of variability. An example of this is illustrated in FIG. 8, which shows production variability as a function of time. A y-axis 802 represents production and an x-axis 804 represents time.

A predetermined range 806 defines a production variability range of interest. The evaluator 308 evaluates the production information and identifies times when variability did not satisfy the range 806. In this example, such times are indicated at 808, 810 and 812. The evaluator 308 generates a signal indicating when production variability was within the predetermined range 806 and when production variability was not within the predetermined range 806.

Returning to FIG. 3, in another example, the criteria 310 may indicate that one or more of the control loops should be utilized at least for a predetermined amount of time such as 90.0%, 95.0%, 99.5%, etc. of the time. Multiple ranges may be used to provide greater granularity. For example, instead of using a binary approach and determining whether utilization has passed or failed, a first range (e.g., >99.5%) may indicate pass, a second rang (e.g., 90-99.5%) may indicate questionable, and a third rang (e.g., <90%) may indicate failure. Any number of ranges and granularity can be used.

FIG. 9 shows an example in which the predetermined utilization threshold 902 is at 95%. In this example, control utilization has failed to meet the predetermined utilization threshold 902 in each evaluated time frame. In FIG. 9, a y-axis 904 represents utilization in % and an x-axis 906 represents time in months. The evaluator 308 generates a signal indicating when the control loop was utilized at least for the predetermined utilization threshold 902 and when it was not.

Returning to FIG. 3, in another example, the predetermined evaluation criteria 310 may indicate a lost time average threshold. An example of this is shown in connection with FIG. 10, in which a y-axis 1002 represents lost time and an x-axis 1004 represents time. In FIG. 10, an average production 1006 over time is also shown. The predetermined evaluation criteria 310 may indicate, for example, a desired lost time or lost time threshold of less than X minutes over the average production 1006. The evaluator 308 generates a signal indicating whether lost time is greater or less than the threshold.

Returning to FIG. 3, the recommender 312 generates a recommendation based on the result of the evaluation. Examples of recommendations include, but are not limited to, verify configuration and tuning for a particular control(s), improve a particular sensor measurement to allow control usage, provide needed operator training on how to use a particular control(s), improve or repair a particular actuator(s) in order to increase utilization of a particular control(s), etc.

The report generator 314 generates a report based on the evaluation results. In one instance, the report is in a format of an electronic data file that can be read by a computer. The report may include various information. By way of non-limiting example, the report may include a list of the controls that satisfied the predetermined level of utilization of interest, a list of the controls that were questionable as to whether they satisfies the predetermined level of utilization of interest, and a list of the controls that did not satisfy the predetermined level of utilization of interest.

For questionable and underutilized controls, the report generator 314 can include information about actual monthly average and raw daily data (e.g. planned outages or shutdowns, intermittent vs. no usage, any notes related to known process, sensor, or actuator issues related to control usage, see variability increase when control in Auto). This information may help explain why utilization was questionable and under the predetermined level. This information may also facilitate filtering out data that may erroneously impact the results. For example, if production is zero for a particular day and it is known that the plant was shut down, the production data can be discarded.

The benchmark determiner 316 determines a benchmark based on existing evaluated information. For example, for a particular machine, where the machine production and control utilization are deemed acceptable, the data collected and evaluated can be used to determine a benchmark for the machine and/or similar machines. The evaluator 308 can then employ the benchmark during evaluation, for example as part of the evaluation criteria. The benchmark can be changed over time to reflect acceptable changes in performance (increased or decreased).

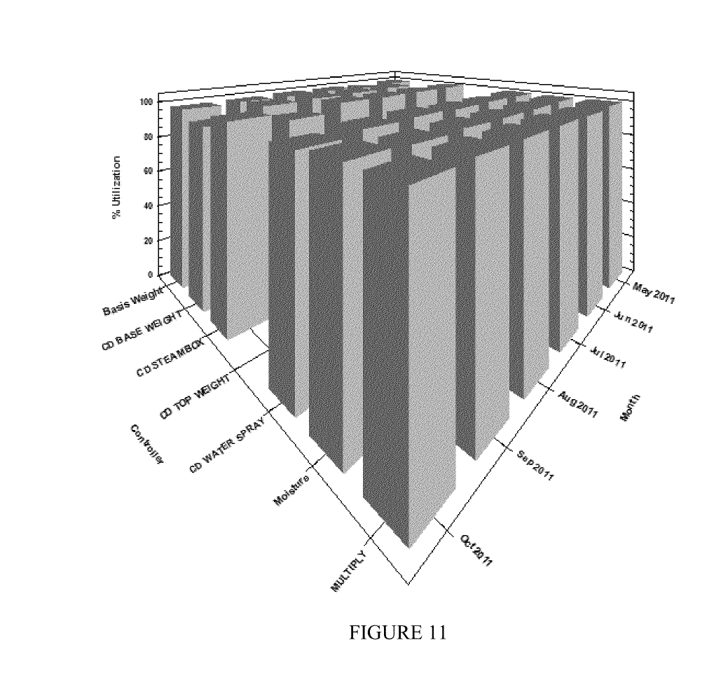

FIGS. 11, 12, 13 and 14 illustrate example report.

FIG. 11 shows monthly utilization in three dimensions, where a y-axis represents % utilization, an x-axis represents the controller, and a z-axis represents the time frame.

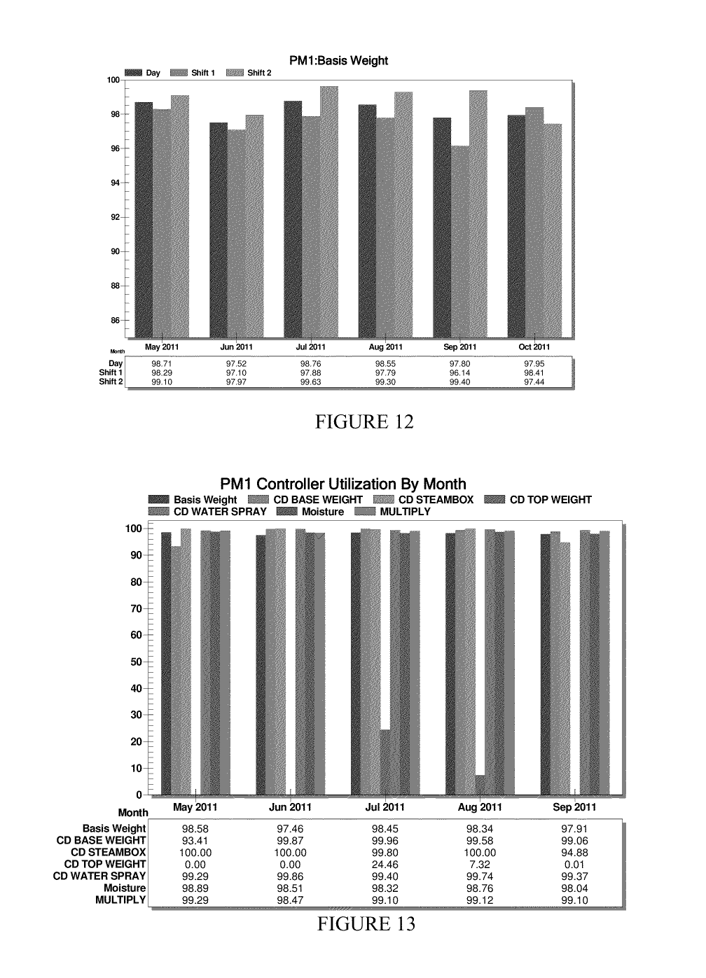

FIG. 12, shows a control utilization bar graph where a y-axis represents % utilization and an x-axis represents time each day and shifts and each month.

FIG. 13, shows a monthly utilization by controller bar graph where a y-axis represents % utilization and an x-axis 1204 represents various control information each month.

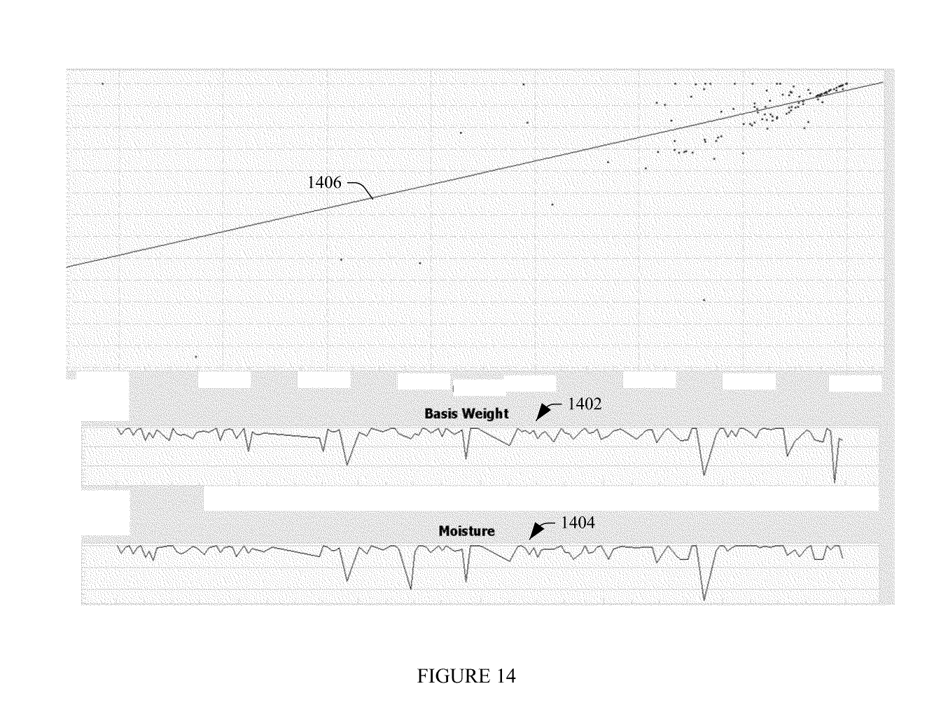

FIG. 14, shows a basic weight trend 1402, a moisture trend 1404 and a combined trend 1406, where all point on the line implies that utilization of basis weight and moisture control are relatively equal, more point above the line implies that moisture control is used more than basis weight control, and more point below the line implies that basis weight control is used more than moisture control.

Other reports and/or combinations of the above reports are also contemplated herein.

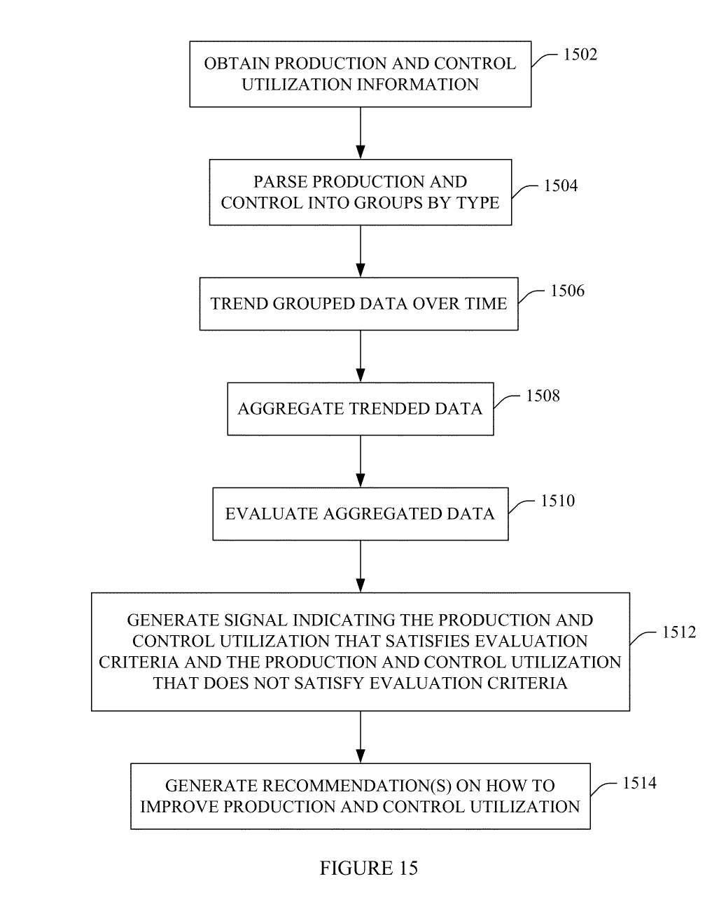

FIG. 15 illustrates an industrial process automation method.

It is to be appreciated that the ordering of the acts in the methods described herein is not limiting. As such, other orderings are contemplated herein. In addition, one or more acts may be omitted and/or one or more additional acts may be included.

At 1502, production and control utilization information for an industrial plant is obtained in electronic format.

At 1504, the production and control utilization information is grouped based on type of the information into a plurality of groups, wherein the information in each group is for a same type of information.

At 1506, information in each group is trended over time.

At 1508, the trended information is aggregated.

At 1510, the aggregated information is evaluated based on predetermined evaluation criteria.

At 1512, an electronic signal indicating the information that satisfied the predetermined evaluation criteria and the information that did not satisfy the predetermined evaluation criteria is generated.

At 1514, optionally, one or more recommendations on how to improve production and/or control utilization is generated based on the evaluation results and included in the electronic signal.

The above may be implemented by way of computer readable instructions, which when executed by a computer processor(s), cause the processor(s) to carry out the described techniques. In such a case, the instructions are stored in a computer readable storage medium associated with or otherwise accessible to the relevant computer.

Of course, modifications and alterations will occur to others upon reading and understanding the preceding description. It is intended that the invention be construed as including all such modifications and alterations insofar as they come within the scope of the appended claims or the equivalents thereof.

What is claimed is:

1. A method, comprising:
obtaining production and control utilization information for an industrial plant, wherein the information is in an electronic format and collected over time;
grouping the information, based on a type of the information, into a plurality of groups, wherein the information in each group is for a same type of information;
trending the information in each group over time;
aggregating the trended information;
evaluating the aggregated information based on predetermined evaluation criteria; and
generating an electronic signal indicating the information that satisfied the predetermined evaluation criteria and the information that did not satisfy the predetermined evaluation criteria.

2. The method of claim 1, further comprising:
generating a recommendation on how to improve at least one of production or control utilization based on the evaluation and including the recommendation in the electronic signal.

3. The method of claim 1, wherein the predetermined evaluation criteria indicates a threshold level of control utilization, and further comprising:
evaluating the aggregated control utilization information based on the threshold level of control utilization, wherein the electronic signal indicates a first sub-set of the control loops that satisfied the level of control utilization and a second sub-set of the control loops that satisfied the level of control utilization.

4. The method of claim 1, wherein the predetermined evaluation criteria indicates a plurality of ranges of control utilization, and further comprising:
evaluating the aggregated control utilization information based on the plurality of ranges of control utilization, wherein the electronic signal indicates a sub-set of the control loops that falls within each of the plurality of ranges.

5. The method of claim 1, wherein the predetermined evaluation criteria indicates a range of variability of production, and further comprising:
evaluating the aggregated production information based on the range of variability of production output, wherein the electronic signal indicates a first sub-set of the control loops that falls within the range and a second sub-set that falls outside of the range

6. The method of claim 1, wherein the predetermined evaluation criteria indicates a lost time threshold over an average lost time, and further comprising:
evaluating the aggregated production information based on the threshold, wherein the electronic signal indicates a first sub-set of the control loops that satisfies the threshold and a second sub-set that falls to satisfy the threshold.

7. The method of claim 1, wherein the electronic signal includes a comparison of control utilization for at least two different control utilization types.

8. The method of claim 1, further comprising:
determining a benchmark based on existing evaluated information; and
using the benchmark as the evaluation criteria.

9. The method of claim 1, wherein the industrial plant is a pulp and paper plant, and the production information includes one or more of output, thruput reel speed, run time, or lost time.

10. The method of claim 1, wherein the industrial plant is a pulp and paper plant, and the control utilization information includes one or more of machine direction control loop or cross direction control loop.

11. A system, comprising:
memory that stores computer executable instructions; and
a processor that executes the computer executable instructions, wherein executing the computer executable instructions causes the processor to implement:
a parser that groups production and control utilization information for an industrial plant, based on a type of the information, into a plurality of groups, wherein the information in each group is for a same type of information;
a trender that trends the information in each group over time;
an aggregator that aggregates the trended information;
an evaluator that evaluates the aggregated information based on predetermined evaluation criteria; and
a report generator that generates an electronic signal indicating the information that satisfied the predetermined evaluation criteria and the information that did not satisfy the predetermined evaluation criteria.

12. The system of claim 11, wherein executing the computer executable instructions causes the processor to further implement:
a recommender that generates a recommendation on how to improve at least one of production or control utilization based on the evaluation, wherein the recommendation is included in the electronic signal.

13. The system of claim 11, wherein the predetermined evaluation criteria indicates a threshold level of control utilization, and that the evaluator evaluates the aggregated control utilization information based on the threshold level of control utilization, wherein the electronic signal indicates a first sub-set of the control loops that satisfied the level of control utilization and a second sub-set of the control loops that satisfied the level of control utilization.

14. The system of claim 11, wherein the predetermined evaluation criteria indicates a plurality of ranges of control utilization, and that the evaluator evaluates the aggregated control utilization information based on the plurality of ranges of control utilization, wherein the electronic signal indicates a sub-set of the control loops that falls within each of the plurality of ranges.

15. The system of claim 11, wherein the predetermined evaluation criteria indicates a range of variability of production, and that the evaluator evaluates the aggregated production information based on the range of variability of production output, wherein the electronic signal indicates a first sub-set of the control loops that falls within the range and a second sub-set that falls outside of the range

16. The system of claim 11, wherein the predetermined evaluation criteria indicates a lost time threshold over an average lost time, and the evaluator evaluates the aggregated production information based on the threshold, wherein the electronic signal indicates a first sub-set of the control loops that satisfies the threshold and a second sub-set that falls to satisfy the threshold.

17. The system of claim 11, wherein the electronic signal includes a comparison of control utilization for at least two different control utilization types.

18. The system of claim 11, wherein executing the computer executable instructions causes the processor to further implement:
a benchmark determiner that determines a benchmark based on existing evaluated information, wherein the benchmark is used as the evaluation criteria.

19. The system of claim 11, wherein the industrial plant is a pulp and paper plant, and the production information includes one or more of output, thruput reel speed, run time, or lost time, and the control utilization information includes one or more of machine direction control loop or cross direction control loop.

20. A computer readable storage medium encoded with one or more computer executable instructions, which, when executed by a processor of a computing system, causes the processor to:
obtain production and control utilization information for an industrial plant, wherein the information is in an electronic format and collected over time;
group the information, based on a type of the information, into a plurality of groups, wherein the information in each group is for a same type of information;
trend the information in each group over time;
aggregate the trended information;
evaluate the aggregated information based on predetermined evaluation criteria; and
generate an electronic signal indicating the information that satisfied the predetermined evaluation criteria and the information that did not satisfy the predetermined evaluation criteria.
